(19) United States
(12) Patent Application Publication
(10) Pub. No.: US 2009/0182573 A1
(43) Pub. Date: Jul. 16, 2009

(54) Multi-Party Payment System for Online Creative Works Sale

(76) Inventor: James M. Lidestri, Hopewell Junction, NY (US)

Correspondence Address: FISH & RICHARDSON P.C., P.O BOX 1022, Minneapolis, MN, 55440-1022, US

(21) Appl. No.: 12/354,961

(22) Filed: Jan. 16, 2009

Related U.S. Application Data
(60) Provisional application No. 61/021,577, filed on Jan. 16, 2008.

(51) Int. Cl. G06Q 30/00

(52) U.S. Cl. 705/1

(57) ABSTRACT

A computer-implemented method of managing royalties for the online sale of a creative work includes selecting a digital creative work for sale from a plurality of digital creative works stored in digital memory, assigning a royalty scheme from a plurality of royalty schemes to the digital creative work, and identifying at least one royalty party from a plurality of royalty parties. A royalty rate is assigned to the at least one royalty party, the royalty rate conforming to the royalty scheme, and a royalty payment to the at least one royalty party is automatically calculated based on the royalty rate, upon the occurrence of an online sale of the digital creative work.

### CROSS-REFERENCE TO RELATED APPLICATION

The present application claims the benefit of U.S. Prov. Pat. App. No. 61/021,577, filed on Jan. 16, 2008, under 35 U.S.C. §119(e). U.S. Prov. Pat. App. No. 61/021,577 is expressly incorporated herein by reference in its entirety for all purposes.

### TECHNICAL FIELD

The present disclosure relates to payment for online creative works, and more particularly to computer-implemented methods, computer readable medium, and systems for distributing monies resulting from the sale of online creative works.

### BACKGROUND

The advent of the Internet has enabled the transfer of information and data to millions of users worldwide. The Internet has also enabled electronic commerce, or e-commerce, which includes the buying and selling of products and/or services over electronic systems such as the Internet, and other computer networks. The amount of electronic trade has rapidly grown over the last decade or so.

Products that are sold through c-commerce can include creative works that are provided in electronic form. Such creative works can include digital writings (e.g., books, papers, articles), digital documents (e.g., spreadsheets, databases, files), software applications, images, photos and videos. Digital creative works can be advertised online through a seller website, for example, and can be electronically transferred to a buyer, upon purchase. Payment for the digital creative works can be made using electronic transfer of funds. Some websites enable users to post their own creative works for sale, or creative works, in which the particular user has rights to post for sale. The online sale of digital creative works can post significant problems in the distribution of sales profits to parties involved in the creation and distribution of such works.

### SUMMARY

The present disclosure is directed to computer-implemented methods, computer readable medium, and systems for managing monies resulting from the sale of online creative works. In some implementations, a computer-implemented method includes selecting a digital creative work for sale from a plurality of digital creative works stored in digital memory, assigning a royalty scheme from a plurality of royalty schemes to the digital creative work, and identifying at least one royalty party from a plurality of royalty parties. The method further includes assigning a royalty rate to the at least one royalty party, the royalty rate conforming to the royalty scheme, and automatically calculating a royalty payment to the at least one royalty party based on the royalty rate, upon the occurrence of an online sale of the digital creative work.

In some implementations, the method further includes confirming a user's rights in the digital creative work, the user assigning the royalty scheme and royalty rate.

In some implementations, the method further includes entering a unique identification number corresponding to one of a plurality of stored profiles, wherein the identifying at least one royalty party is performed based on the unique identification number.

In some implementations, each royalty party includes an associated profile, which includes a pre-determined royalty rate, which pre-determined royalty rate is automatically assigned as the royalty rate upon identifying the at least one royalty party.

In other implementations, the method further includes posting the digital creative work for online sale after an authority reviews the at least one royalty party and the royalty rate associated therewith.

In still other implementations, the method further includes storing a royalty profile that comprises a plurality of royalty parties and associated royalty rates, and selecting the royalty profile from a plurality of royalty profiles, wherein the identifying and the assigning are executed based on information stored in the royalty profile.

In some implementations, the method further includes transferring the royalty payment to the at least one royalty party.

In some implementations, a computer readable medium encoded with a computer program comprising instructions that, when executed, operate to cause a computer to perform operations including receiving input from a user, selecting a digital creative work for sale from a plurality of digital creative works stored in computer memory based on the input, assigning a royalty scheme from a plurality of royalty schemes to the digital creative work based on the input, and identifying at least one royalty party from a plurality of royalty parties based on the input, each of which includes an associated profile stored in computer memory. A royalty rate is assigned to the at least one royalty party based on the input, the royalty rate conforming to the royalty scheme. A royalty payment to the at least one royalty party is automatically calculated based on the royalty rate, upon the occurrence of an online sale of the digital creative work.

In some implementations, a system includes a network, and a computer that communicates over the network. The computer includes a computer-readable medium encoded with a computer program comprising instructions that, when executed, operate to cause a computer to perform operations. The operations include receiving input from a user, selecting a digital creative work for sale from a plurality of digital creative works stored in computer memory based on the input, assigning a royalty scheme from a plurality of royalty schemes to the digital creative work based on the input, identifying at least one royalty party from a plurality of royalty parties based on the input, each of which includes an associated profile stored in computer memory, assigning a royalty rate to the at least one royalty party based on the input, the royalty rate conforming to the royalty scheme, and automatically calculating a royalty payment to the at least one royalty party based on the royalty rate, upon the occurrence of an online sale of the digital creative work over the network.

The details of one or more implementations of the present disclosure are set forth in the accompanying drawings and the description below. Other features, objects, and advantages of the invention will be apparent from the description and drawings, and from the claims.

### DESCRIPTION OF DRAWINGS

FIG. 1 is a functional block diagram of an exemplar system.

FIG. 2 is an illustration of an exemplar screen-shot of an implementation of the present disclosure.

FIG. 3 is a flowchart illustrating exemplar steps executed in accordance with some implementations of the present disclosure.

### DETAILED DESCRIPTION

The present disclosure is directed to a process that enables multiple parties to be assigned royalties for the online sale of a creative work. Such creative work can include, but is not limited to, photos, videos, music, audio files, graphic/visual art, digital writings (e.g., books, papers, articles, technical documentation), digital documents (e.g., spreadsheets, databases, files, and software applications.

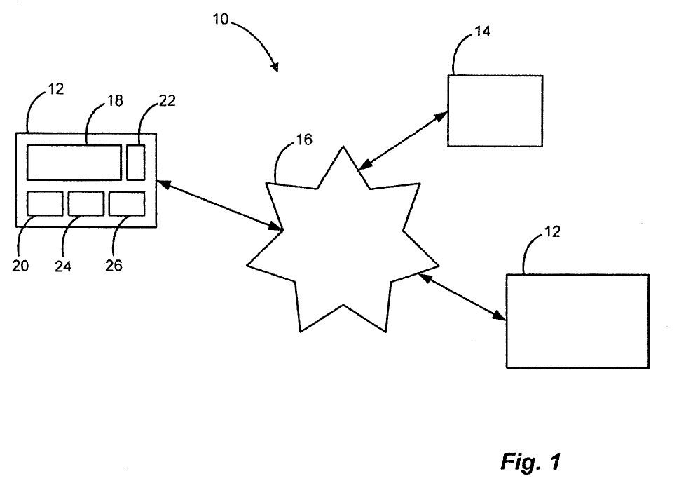

Referring now to FIG. 1, an exemplar system for implementing the process of the present disclosure is illustrated. An exemplar computer network 10 includes a plurality of computers 12, and one or more servers 14 that communicate with one another over a network 16. The network 16 can include, but is not limited to, a local area network (LAN), a wide area network (WAN), and/or the Internet. An exemplar computer 12 includes a display 18, an input device 20, such as a keyboard and/or mouse, memory 22, a dataport 24, and a central processing unit (CPU) 26. The display 18 can include a CRT (cathode ray tube) or LCD (liquid crystal display) monitor for displaying information to the user. The input device 20 can include a keyboard, and/or a pointing device such as a mouse or a trackball, by which the user can provide input to the computer 12. Other kinds of devices can be used to provide for interaction with a user as well; for example, input from the user can be received in any form, including acoustic, speech, or tactile input.

A software program that executes one or more implementations of the present disclosure can be resident on one or more of the computers 12, and/or on the server 14. For example, the software program can be resident on a particular computer 12, which the user implements to execute the process of the present disclosure. Additionally, or in the alternative, the user can access a website through the network 16. The user performs the content selection, and royalty rate assignment, as described herein, using the website.

Implementations of the processes of the present disclosure enable a user to select a digital creative work for sale. As used herein, the user includes a person, or persons, who make available, or otherwise distribute a digital creative work. By way of non-limiting example, the user can include, but is not limited to, an artist, an author, a model, a photographer, an actor, a videographer, an agent, a publisher, a programmer and/or a third party, to which rights in the digital creative work have been assigned. The digital creative work is presumably one, in which the user has rights to sell and/or distribute. However, the user's rights in the digital creative work can be authenticated or confirmed. An exemplar means for authenticating the user's rights in the digital creative work is described below. For example, the user can enter a unique identification number, a name, a location, and/or other verification information to authenticate the user's access to a particular digital creative work that is to be selected for multiple royalty payments.

The process further enables the user to identify each of the multiple royalty parties and to assign a royalty rate to each of the multiple royalty parties. A royalty party can be anyone involved in the creation and/or distribution of the digital creative work. By way of non-limiting example, a royalty party can include, but is not limited to, an artist, an author, a model, a photographer, an actor, a videographer, an agent, a publisher, a programmer, and/or a third party, to which royalties in the digital creative work have been assigned. It is anticipated that the user themselves can be one of the royalty parties. The user can input information to identify each royalty party, such as inputting a unique identification associated with the royalty party, and/or a royalty party can be identified by searching a database(s) based on the user provided information. Upon searching the database(s) some or all of the searched information can be displayed to the user, and the user can select the appropriate royalty party.

The digital creative work, or content is subsequently posted for sale to a website, which can be accessible through the network (e.g., Internet). It is anticipated, however, that the content can be reviewed by the user, and/or one or more of the royalty parties prior to posting. In this manner, the reviewing party can accept or reject posting of the content. Such a review process can be discretionary or mandatory prior to posting the content.

A customer can purchase the digital creative work by accessing the website through a network portal, such as a computer that is able to communicate with the network. Subsequent to the sale of selected digital creative work, sales royalties are calculated in accordance with the assigned royalty party rates, which were input by the user. The royalty monies are either electronically, or physically distributed to the royalty parties. More specifically, royalty payments can be sent to the user, to one of the royalty parties, and/or to each royalty party, either through an electronic bank transfer/check, or by sending a physical check(s). The sum of the multiple party rates can be tallied, and the sum can be displayed to the user prior to distributing the royalty monies.

The user can select the digital creative work, or content, for sale from a website, from a local computer system, or from a uniform resource locator (URL) to the location of the digital creative work. In any case, the user can be required to provide user credentials, or some other form of identification verification. When assigning the royalty rates to the one or more royalty parties, the user can input an identification number that is unique to each royalty party. For example, the user can input the name of the royalty party, and/or a unique identification number associated with a particular royalty party. The royalty rate conforms to a chosen royalty scheme. For example, the royalty rate can be provided as a percentage (e.g., the sum of all of the royalty rates does not exceed 100%), can be provided as a fixed amount (e.g., a royalty party receives $X per each sale), and/or can be provided as a variable amount (e.g., the royalty rate for a particular party increases as the number of sales increases).

Other arrangements of royalty rates can also be implemented. For example, the user can input a minimum threshold for royalty payments for the multiple party rates. Consequently, no royalty payments are paid unless the royalties exceed the minimum threshold. As another example, the user can input a minimum threshold for royalty payments for each of the royalty parties. Consequently, royalties are paid only if the royalties to the particular royalty party exceeds the minimum threshold associated with that royalty party. In either case, it is anticipated that the minimum thresholds can be automatically generated, or can be input, or modified by the user.

In other implementations, the user can utilize a multi-level royalty scheme. Such scheme would pay one set of assigned royalty rates for the first $X of sales and a different set of assigned royalty rates for the next $Y of sales, and so forth. Users can also assign maximum royalty rates to some of the royalty parties, such that the royalty party with the maximum royalty could not earn more than X % of total sales or no more than $Y.

In some implementations, the user can store in a profile, the collection of assigned royalty rates to the multiple royalty parties, as well as the identification numbers, names and/or locations of the content corresponding thereto. In this manner, the user can select the stored values upon subsequent uses.

The user can determine the sales price of the content, and can input the sales price information. The sales price can be one that is specified by the user and/or can be selected by the user from a list of pre-determined sales prices. In another implementation, the sales price can be automatically determined based on the type of content. For example, if the content includes an image, the sales price can be automatically provided as $X, and if the content includes a video, the sales price can be automatically provided as $Y. The system may have a more complex formula for automatically determining the sales price of the content.

It is also contemplated that multiple users and/or multiple royalty parties can input the assigned royalty rates. For example, each royalty party can input their anticipated royalty rate, and a check can be executed to ensure that the sum of the royalty rates does not exceed a threshold (e.g., in the case of percentage royalty rates, the sum does not exceed 100%).

In some implementations, it is contemplated that the assigned royalty rates can be reviewed by the user, the publisher, and/or one or more of the royalty parties prior to posting the content. For example, the content is not posted unless an appropriate authority approves of the royalty arrangement.

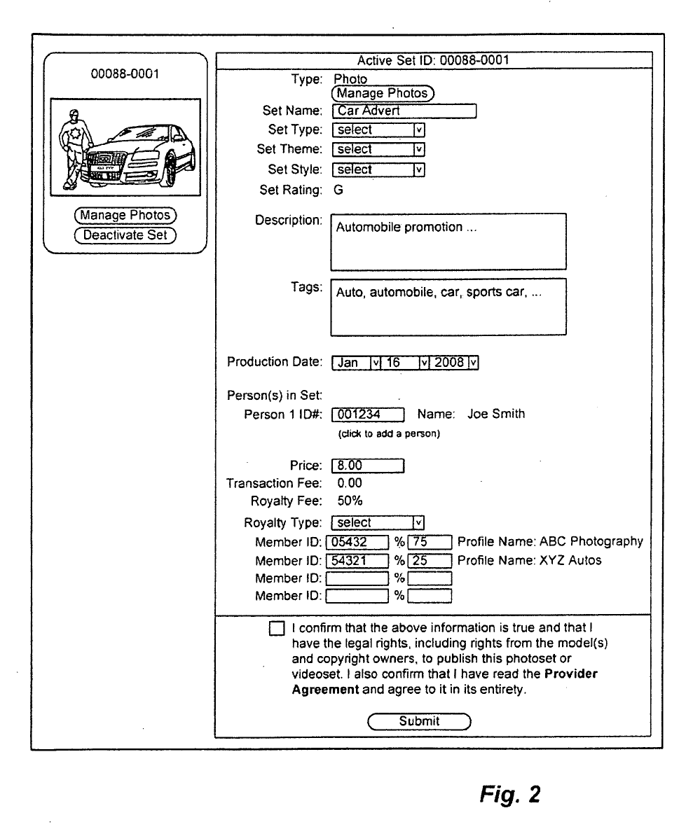

Referring now to FIG. 2, an illustration of a screen-shot of an exemplar implementation of the present disclosure is provided. The screen-shot includes a first pane that provides a thumbnail photo that is representative of a group, or set of photos, videos, or other content. A second pane is provided, through which the user is able to set parameters relating to the content including the assignment of royalties for sales of the content. The user can input set information including, but not necessarily limited to, a set name, a set type, a set theme, a set style, a description, tags, production date, and copyright owner(s) in the set (e.g., a model). The user can also input information corresponding to sales of the content. For example, the user can provide a price, a royalty type, can identify royalties parties, and can assign royalty rates to each.

Exemplar set types can include, but are not limited to, professional, amateur, candid, self, vehicle type. Exemplar set themes can include, but are not limited to, classic cars, hot rods, roadsters, sports cars, cruisers, portfolio, glamour, casual, fitness, fetish and swimwear. Exemplar set styles can include, but are not limited to, candid, formal, action, exhibition, non-nude, nude, implied, topless and erotic. The user can provide a description of the set, which description can be posted for review by potential purchasers of the content. The user can also provide tags, which are keywords that describe the content. In this manner, a potential purchaser can input search terms into a search engine, which search terms may correspond to the tags. The user can also input the production date of the content, as well as identifying the person(s) (e.g., a model) involved in the content production. The person(s) can have an identification that corresponds to a pre-stored profile that includes all relevant information associated with the person(s). For example, after inputting the identification, the person's name is automatically displayed. As a note, although pull-down menus are illustrated, it is contemplated that other input means can be implemented.

As noted above, the user can input a sales price for the content, which forms the basis for subsequent royalty payments. In the example of FIG. 2, a transaction fee and a royalty rate are provided, which correspond to payments to be made to third-parties upon a sale of the content. The transaction fee can correspond to a fee paid to an Internet Service Provider (ISP), for example, and the royalty rate can correspond to a royalty paid to the owner of the website, through which the content is sold. Such fees can be pre-set, and may not be editable by the user. The royalty type can be selected based on the royalty scheme determined by the user. For example, in the case of straight royalty percentages to be paid, the royalty type can be set to ‘percentage’. Other examples include fixed payments, as well as those described in detail herein. To assign a royalty rate, a member identification is input, and the royalty amount is input. In the example of FIG. 2, the member identification ‘05432’ corresponds to ‘ABC Photography’ and a royalty rate of 75% has been assigned. The member identification ‘54321’ corresponds to ‘XYZ Autos’ and a royalty rate of 25% has been assigned.

Upon inputting the information, the user confirms that he/she has the requisite rights in the content. In the example of FIG. 2, confirmation is made by reading a confirmation paragraph and checking the corresponding check box. Other confirmation methods, however, are contemplated including, but not limited to, those described in detail above.

Using the exemplar values of FIG. 2, the royalty payments for a sale of the exemplar set would breakdown as follows: a sale is made at a price of $8.00 (US dollars in this example), no transaction fee is paid, a royalty fee of $4.00 (i.e., 50% of the $8.00 sales price) is paid to the website owner, for example. A royalty payment of $3.00 (i.e., 75% of the remaining $4.00) is paid to ABC Photography, and a royalty payment of $1.00 (i.e., 25% of the remaining $4.00) is paid to XYZ Autos.

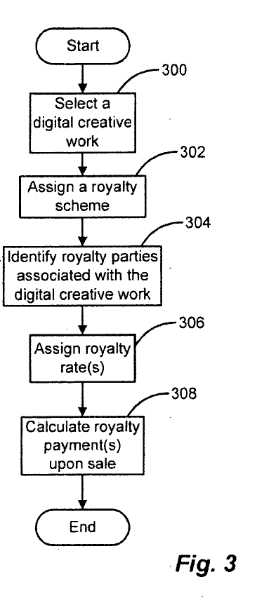

Referring now to FIG. 3, a flowchart illustrating exemplar steps that can be executed in implementations of the present disclosure are provided. In step 300, a digital creative work is selected. The digital creative work can be selected from a plurality of digital creative works stored in computer memory. In step 302, a royalty scheme is assigned. The royalty scheme can be one of a plurality of royalty schemes. In step 304, at least one royalty party is identified, which royalty party is associated with the digital creative work. The royalty party is identified from a plurality of royalty parties, each of which includes an associated profile stored in computer memory. A royalty rate is assigned in step 306. The royalty rate is assigned to the royalty party, and conforms to the royalty scheme. In step 308, a royalty payment to the royalty party is automatically calculated based on the royalty rate, upon the occurrence of an online sale of the digital creative work.

It is appreciated that the steps of FIG. 3 are exemplar steps, and that the present disclosure can be implemented in processes including the same steps, more steps, or fewer steps. For example, other steps can include confirming a user's rights in the digital creative work, the user assigning the royalty scheme and royalty rate, entering a unique identification number corresponding to one of a plurality of stored profiles, wherein the identifying at least one royalty party is performed based on the unique identification number, and/or each associated profile including a pre-determined royalty rate, which pre-determined royalty rate is automatically assigned as the royalty rate upon identifying the at least one royalty party. Other exemplar steps can include posting the digital creative work for online sale after an authority reviews the at least one royalty party and the royalty rate associated therewith, storing a royalty profile that comprises a plurality of royalty parties and associated royalty rates, and/or selecting the royalty profile from a plurality of royalty profiles, wherein the identifying and the assigning are executed based on information stored in the royalty profile.

The processes of the present disclosure can be implemented in digital electronic circuitry, or in computer hardware, firmware, software, or in combinations thereof. The invention can be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Implementations of the present disclosure can be performed by one or more programmable processors executing a computer program to perform functions of the invention by operating on input data and generating output. Processes can also be performed by, and apparatus can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

Processes of the present disclosure can be implemented in a computing system that includes a back-end component, e.g., as a data server, or that includes a middleware component, e.g., an application server, or that includes a front-end component, e.g., a client computer having a graphical user interface or an Web browser through which a user can interact with an implementation of the invention, or any combination of such back-end, middleware, or front-end components. The components of the system can be interconnected by any form or medium of digital data communication, e.g., a communication network. Examples of communication networks include a local area network, a wide area network, and the Internet.

A number of implementations of the disclosure have been described. Nevertheless, it will be understood that various modifications may be made without departing from the spirit and scope of the disclosure. More specifically, implementations of the method and system of the present disclosure can include various combinations of the features described herein. For example, implementations of the method and system can include a plurality of the features described herein, while other implementations can include all of the features described herein.

What is claimed is:

1. A computer-implemented method of managing royalties for the online sale of a creative work, comprising:
selecting a digital creative work for sale from a plurality of digital creative works stored in digital memory;
assigning a royalty scheme from a plurality of royalty schemes to the digital creative work;
identifying at least one royalty party from a plurality of royalty parties;
assigning a royalty rate to the at least one royalty party, the royalty rate conforming to the royalty scheme; and
automatically calculating a royalty payment to the at least one royalty party based on the royalty rate, upon the occurrence of an online sale of the digital creative work.

2. The method of claim 1, further comprising confirming a user's rights in the digital creative work, the user assigning the royalty scheme and royalty rate.

3. The method of claim 1, further comprising entering a unique identification number corresponding to one of a plurality of stored profiles, wherein the identifying at least one royalty party is performed based on the unique identification number.

4. The method of claim 1, wherein each royalty party has an associated profile that includes a pre-determined royalty rate, which pre-determined royalty rate is automatically assigned as the royalty rate upon identifying the at least one royalty party.

5. The method of claim 1, further comprising posting the digital creative work for online sale, after an authority reviews the at least one royalty party and the royalty rate associated therewith.

6. The method of claim 1, further comprising:
storing a royalty profile that comprises a plurality of royalty parties and associated royalty rates; and
selecting the royalty profile from a plurality of royalty profiles, wherein the identifying and the assigning are executed based on information stored in the royalty profile.

7. The method of claim 1, further comprising transferring the royalty payment to the at least one royalty party.

8. A computer-readable medium encoded with a computer program comprising instructions that, when executed, operate to cause a computer to perform operations comprising:
receiving input from a user;
selecting a digital creative work for sale from a plurality of digital creative works stored in digital memory based on the input;
assigning a royalty scheme from a plurality of royalty schemes to the digital creative work based on the input;
identifying at least one royalty party from a plurality of royalty parties based on the input;
assigning a royalty rate to the at least one royalty party based on the input, the royalty rate conforming to the royalty scheme; and
automatically calculating a royalty payment to the at least one royalty party based on the royalty rate, upon the occurrence of an online sale of the digital creative work.

9. The computer-readable medium of claim 8, wherein the operations further comprise confirming a user's rights in the digital creative work, the user assigning the royalty scheme and royalty rate.

10. The computer-readable medium of claim 8, wherein the input includes a unique identification number corresponding to one of a plurality of stored profiles, wherein the identifying at least one royalty party is performed based on the unique identification number.

11. The computer-readable medium of claim 8, wherein each royalty party has an associated profile that includes a pre-determined royalty rate, which pre-determined royalty rate is automatically assigned as the royalty rate upon identifying the at least one royalty party.

12. The computer-readable medium of claim 8, further comprising posting the digital creative work for online sale, after an authority reviews the at least one royalty party and the royalty rate associated therewith.

13. The computer-readable medium of claim 8, wherein the operations further comprise:
storing a royalty profile that comprises a plurality of royalty parties and associated royalty rates; and
selecting the royalty profile from a plurality of royalty profiles based on the input, wherein the identifying and the assigning are executed based on information stored in the royalty profile.

14. The computer-readable medium of claim 8, wherein the operations further comprise transferring the royalty payment to the at least one royalty party.

15. A system, comprising:
a network;
a computer that communicates over the network, and that has a computer-readable medium encoded with a computer program comprising instructions that, when executed, operate to cause a computer to perform operations comprising:
receiving input from a user;
selecting a digital creative work for sale from a plurality of digital creative works stored in digital memory based on the input;
assigning a royalty scheme from a plurality of royalty schemes to the digital creative work based on the input;
identifying at least one royalty party from a plurality of royalty parties based on the input;
assigning a royalty rate to the at least one royalty party based on the input, the royalty rate conforming to the royalty scheme; and
automatically calculating a royalty payment to the at least one royalty party based on the royalty rate, upon the occurrence of an online sale of the digital creative work over the network.

16. The system of claim 15, wherein the operations further comprise confirming a user's rights in the digital creative work, the user assigning the royalty scheme and royalty rate.

17. The system of claim 15, wherein the input includes a unique identification number corresponding to one of a plurality of stored profiles, wherein the identifying at least one royalty party is performed based on the unique identification number.

18. The system of claim 15, wherein each royalty party has an associated profile that includes a pre-determined royalty rate, which pre-determined royalty rate is automatically assigned as the royalty rate upon identifying the at least one royalty party.

19. The system of claim 15, further comprising posting the digital creative work for online sale over the network, after an authority reviews the at least one royalty party and the royalty rate associated therewith.

20. The system of claim 15, wherein the operations further comprise:
storing a royalty profile that comprises a plurality of royalty parties and associated royalty rates; and
selecting the royalty profile from a plurality of royalty profiles based on the input, wherein the identifying and the assigning are executed based on information stored in the royalty profile.

21. The system of claim 15, wherein the operations further comprise transferring the royalty payment to the at least one royalty party.
